(19) United States
(12) Patent Application Publication
(10) Pub. No.: US 2010/0308962 A1
(43) Pub. Date: Dec. 9, 2010

(54) METHOD AND ELECTRONIC DEVICE CAPABLE OF USER IDENTIFICATION

(75) Inventor: YU-LUN LI, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/551,709

(22) Filed: Sep. 1, 2009

(30) Foreign Application Priority Data
Jun. 4, 2009 (CN) 200910302927.X

(51) Int. Cl. G05B 19/00

(52) U.S. Cl. 340/5.83

(57) ABSTRACT

An electronic device and method capable of user identification are disclosed. The electronic device includes a memory unit configured for storing a preset fingerprint therein, a wireless receiver, a stylus having a fingerprint sensor and a wireless transmitter. The fingerprint sensor captures a captured fingerprint from a finger when the finger is placed on the fingerprint sensor, and the wireless transmitter transmits the captured fingerprint to the wireless receiver for user identification by comparing the preset fingerprint with the captured fingerprint.

### BACKGROUND

1. Technical Field

The present disclosure relates to information processing technology, and particularly to a method and electronic device capable of user identification.

2. Description of Related Art

In order to gain access to applications or other resources via a computer or other electronic device, users are often required to authenticate themselves by entering authentication information. Such authentication information may comprise, for example, passwords that are generated by a security token carried by the user. These passwords may be one-time passwords generated using a time-synchronous or event-based algorithm and passwords set up by the user. Other types of authentication information may include, for example, answers to personal questions.

A problem that arises in conventional authentication arrangements of the type described above is that the user typically has to provide authentication information separately for each application or other resource to be accessed. However, the user may forget the personal identification number (PIN) or password.

### BRIEF DESCRIPTION OF THE DRAWINGS

FIG. 1 is a block diagram of one embodiment of an electronic device capable of user identification of the present disclosure.

FIG. 2 is an operational diagram of the electronic device in FIG. 1 as a finger is placed on the fingerprint sensor.

FIG. 3 is an operational diagram of the electronic device in FIG. 1 as no finger is placed on the fingerprint sensor.

FIG. 4 is a flowchart of one embodiment of a method for identification used in the electronic device of the present disclosure.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

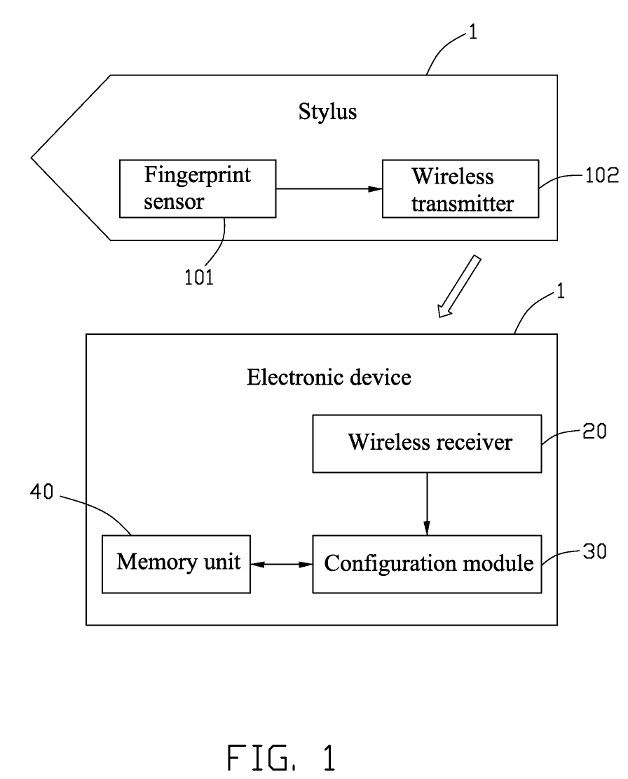

FIG. 1 is a block diagram of one embodiment of an electronic device capable of user identification. The electronic device 1 includes a configuration module 30, a memory unit 40 configured for storing a preset fingerprint, a wireless receiver 20 and a stylus 10 including a fingerprint sensor 101 and a wireless transmitter 102. The fingerprint sensor 101 captures a captured fingerprint from a finger when the finger is placed on the fingerprint sensor 101, and the wireless transmitter 102 transmits the captured fingerprint to the wireless receiver 20 for user identification by comparing the preset fingerprint with the captured fingerprint. In the embodiment, the electronic device 1 is a smart phone. In other embodiments, the electronic device 1 may be a personal digital assistant (PDA), handheld computer, or other device is equally applicable.

The electronic device 1 is generally controlled and coordinated by operating system such as UNIX, Linux, Windows, Mac OS, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

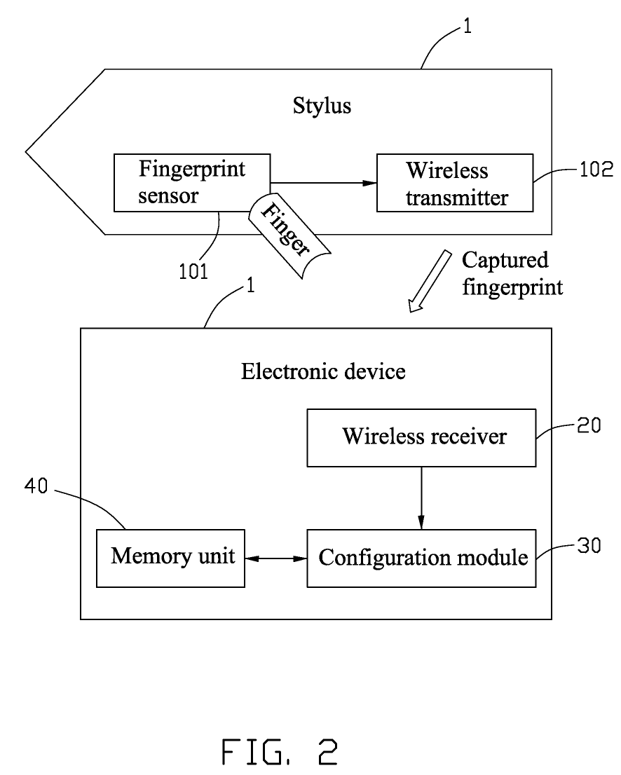

The fingerprint sensor 101 comprises one or more sensors configured for capturing a fingerprint of a user. Referring to FIG. 2, upon capturing the fingerprint by the fingerprint sensor 101, the wireless transmitter 102 of the stylus 10 transmits the captured fingerprint to the wireless receiver 20.

The wireless receiver 20 transmits the captured fingerprint to the configuration module 30 for comparison with the preset fingerprint. The configuration module 30 is configured for setting an access authority level of the electronic device 1. The default setting of the access authority level is a guest level, and the access authority level is upgraded to an administrator level when the captured fingerprint matches the preset fingerprint. At the guest level, the user is only allowed to operate limited functions and access limited folders in the electronic device 1. Alternatively, at the administrator level, the user is allowed to operate full functions and access all folders in the electronic device 1.

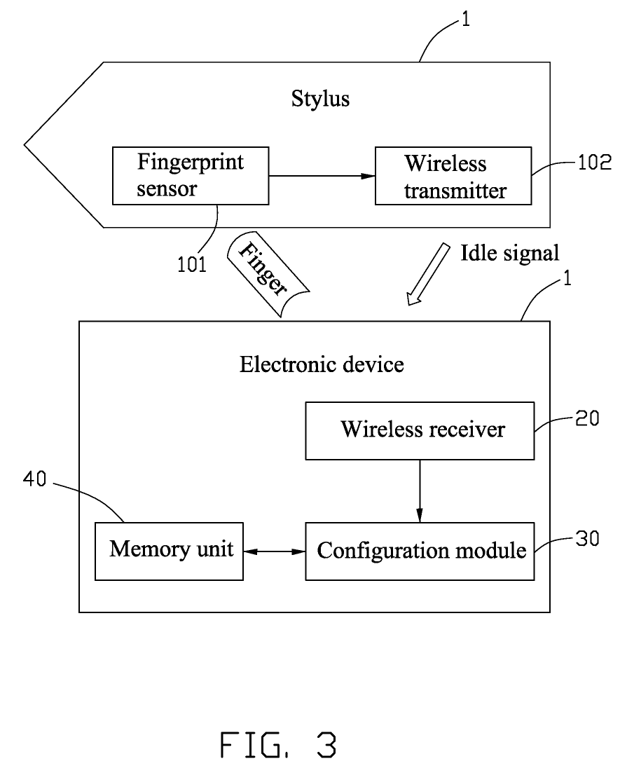

The fingerprint sensor 101 further includes a timer (not shown) therein for periodically checking whether a finger is placed on the fingerprint sensor 101 after the identification is complete. Referring to FIG. 3, if no finger has been placed on the fingerprint sensor 101, the fingerprint sensor 101 transmits an idle signal to the configuration module 30 by the wireless transmitter 102. The configuration module 30 downgrades the access authority level from the administrator level to the guest level upon receiving the idle signal from the fingerprint sensor 101.

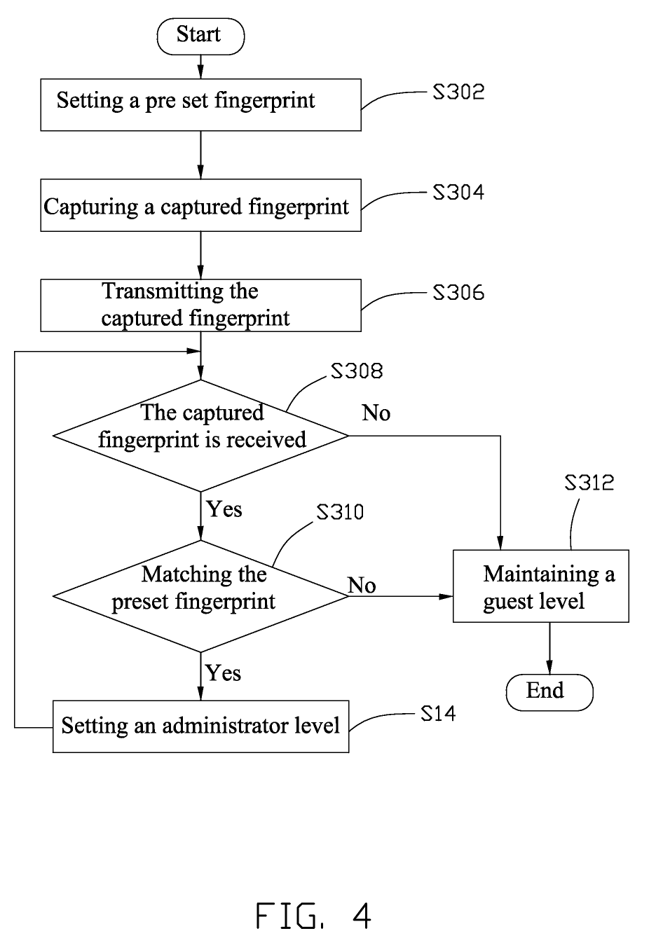

FIG. 4 is a flowchart of one embodiment of a method for identification used in the electronic device 1. Additional blocks may be added to the method, others removed, and the ordering of the blocks may be changed.

In block S302, the configuration module 30 of the electronic device 1 sets a preset fingerprint in the memory unit 40. In one exemplary embodiment, setting the preset fingerprint in the memory unit 40 is completed by executing the steps: (a) capturing a fingerprint by the fingerprint sensor 101, (b) transmitting the fingerprint from the wireless transmitter 102 to the wireless receiver 20, and (c) storing the fingerprint in the memory unit 40 as the preset fingerprint. After completing the above steps, the configuration module 30 further sets the access authority level of the electronic device 1 as a guest level.

In block S304, the fingerprint sensor 101 captures a captured fingerprint and the process goes to block S306. In S306, the wireless transmitter 102 of the stylus 10 transmits the captured fingerprint to the wireless receiver 20 of the electronic device 1.

In block S308, the configuration module 30 periodically checks whether the wireless receiver 20 receives the captured fingerprint. If no captured fingerprint is received by the wireless receiver 20, in block S312, the configuration module 30 maintains the access authority level at the guest level, and the process is complete.

If the wireless receiver 20 receives the captured fingerprint, in block S310, the configuration module 30 compares whether the captured fingerprint matches the preset fingerprint. If the captured fingerprint does not match the preset fingerprint, the process goes to block S312.

If the captured fingerprint matches the pre-defined fingerprint, in block S314, the configuration module 30 sets the access authority level as an administrator level when the captured fingerprint matches the preset fingerprint and the process goes back to block S308 to repeat the above-mentioned processing.

In the electronic device and method of the present disclosure, the configuration module maintains the access authority level of the electronic device at the guest level when no captured fingerprint is received by the wireless receiver or the captured fingerprint does not match the preset fingerprint. Such feature avoids the inconvenience caused by entering password to the electronic device and keeps security of the electronic device when the electronic device is in an idle status.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device capable of user identification comprising:
a configuration module configured for managing an access authority level of the electronic device;
a memory unit configured for storing a preset fingerprint therein;
a wireless receiver;
a stylus having a fingerprint sensor and a wireless transmitter; and
wherein the fingerprint sensor captures a captured fingerprint from a finger when the finger is placed on the fingerprint sensor, and the wireless transmitter transmits the captured fingerprint to the wireless receiver for user identification by comparing the preset fingerprint with the captured fingerprint.

2. The electronic device of claim 1, wherein preset fingerprint is inputted by a user using the fingerprint sensor.

3. The electronic device of claim 2, wherein the access authority level is set as a guest level by the configuration module.

4. The electronic device of claim 3, wherein the access authority level is set as an administrator level by the configuration module when the captured fingerprint matches the preset fingerprint.

5. The electronic device of claim 4, wherein the access authority level is downgraded from the administrator level to the guest level when the captured fingerprint is no longer captured by the fingerprint sensor.

6. The electronic device of claim 5, wherein the configuration module periodically checks whether the wireless receiver receives the captured fingerprint.

7. A computer-implemented method for user identification in an electronic device, the electronic device comprising a memory unit, a wireless receiver, and a stylus, the stylus comprising a fingerprint sensor and a wireless transmitter, the method comprising:
setting a preset fingerprint in the memory unit using the fingerprint sensor;
capturing a captured fingerprint using the fingerprint sensor;
transmitting the captured fingerprint from the wireless transmitter to the wireless receiver; and
comparing whether the captured fingerprint matches the preset fingerprint.

8. The method of claim 7, wherein setting the preset fingerprint in the memory unit further comprising:
capturing a fingerprint using the fingerprint sensor;
transmitting the fingerprint from the wireless transmitter to the wireless receiver; and
storing the fingerprint in the memory unit as the preset fingerprint.

9. The method of claim 8, before capturing the fingerprint, further comprising:
setting an access authority level of the electronic device as a guest level.

10. The method of claim 9, further comprising:
setting the access authority level as an administrator level when the captured fingerprint matches preset fingerprint.

11. The method of claim 10, after the comparing step, the method further comprising:
downgrading the access authority level from the administrator level to the guest level when the captured fingerprint is no longer captured by the fingerprint sensor.

12. The method of claim 8, further comprising:
periodically checking whether the wireless receiver has received the fingerprint.

13. A storage medium having stored thereon instructions that, when executed by a processor, cause the processor to perform a user identification method in an electronic device, the electronic device comprising a memory unit, a wireless receiver, and a stylus, the stylus comprising a fingerprint sensor and a wireless transmitter, the method comprising:
set a preset fingerprint in the memory unit using the fingerprint sensor;
capture a captured fingerprint using the fingerprint sensor;
transmit the captured fingerprint from the wireless transmitter to the wireless receiver; and
compare whether the captured fingerprint matches the preset fingerprint.

14. The storage medium of claim 13, wherein the step of set the preset fingerprint in the memory unit further comprising:
capture a fingerprint using the fingerprint sensor;
transmit the fingerprint from the wireless transmitter to the wireless receiver; and
store the fingerprint in the memory unit as the preset fingerprint.

15. The storage medium of claim 14, before capturing the fingerprint, the method further comprising:
set an access authority level of the electronic device as a guest level.

16. The storage medium of claim 15, wherein the method further comprising:
set the access authority level as an administrator level when the captured fingerprint matches preset fingerprint.

17. The storage medium of claim 16, after the comparing step, wherein the method further comprising:
downgrade the access authority level from the administrator level to the guest level when the captured fingerprint is no longer captured by the fingerprint sensor.

18. The storage medium of claim 14, wherein the method further comprising:
periodically check whether the wireless receiver has received the fingerprint.
